(19) United States
(12) Patent Application Publication
(10) Pub. No.: US 2021/0127156 A1
(43) Pub. Date: Apr. 29, 2021

(54) MONITORING SYSTEM FOR SMART TVS

(71) Applicant: Amlogic (Shenzhen), Ltd., Shenzhen (CN)

(72) Inventor: Wei YU, Shenzhen (CN)

(21) Appl. No.: 17/138,774

(22) Filed: Dec. 30, 2020

Related U.S. Application Data
(63) Continuation of application No. PCT/CN2020/102527, filed on Jul. 17, 2020.

(30) Foreign Application Priority Data
Jul. 23, 2019 (CN) 201910667596.3

(51) Int. Cl. H04N 21/431; G06K 7/14

(52) U.S. Cl. CPC H04N 21/431; G06K 7/1417

(57) ABSTRACT

The system includes an user terminal, a server, and a TV terminal being communicated with each other via Transmission Control Protocol/Internet Protocol (TCP/IP). The TV terminal includes a back-end controller configured to process network requests sent from the user terminal via the server, and to record a total power-on time of the TV terminal. The TV terminal is associated with a QR code or a digital code, and the user terminal is bound to the TV terminal via the QR code or the digital code such that operations of the TV terminal is controllable in accordance with commands inputted on the user terminal.

### CROSS REFERENCE TO RELATED APPLICATIONS

The present application is a continuation-application of International Application PCT/CN2020/102527, with an international filing date of Jul. 17, 2020, which claims foreign priority of Chinese Patent Application No. 201910667596.3, filed on Jul. 23, 2019 in the State Intellectual Property Office of China, the contents of all of which are hereby incorporated by reference.

### BACKGROUND

### 1. Technical Field

The present disclosure relates to a monitoring technology, and particularly to a monitoring system for smart TVs.

### 2. Description of Related Art

Recently, kids and teenagers have been spent a great deal of time on TV problems, and some TV content is not appropriate for the kids and teenagers. According to scientific researches, such issues not only lead to vision problems, but also affect children's imagination and self-control. The best way to solve this problem is to personally supervise the children, but this is, to some extent, difficult. In particular, during winter and summer vacations, parents may not be able to monitor children for most of the time due to they have to go to work.

### BRIEF DESCRIPTION OF THE DRAWINGS

To describe the technical schemes in the embodiments of the present disclosure or in the prior art more clearly, the following briefly introduces the drawings required for the descriptions in the present disclosure. It should be understood that, the drawings in the following description merely show some embodiments of the present disclosure. For those skilled in the art, other drawings can be obtained according to the drawings without creative efforts.

FIG. 1 is a schematic view of an embodiment of a monitoring system for smart TVs according to the present disclosure.

### DETAILED DESCRIPTION

In order to make the objects, features and advantages of the present disclosure more obvious and easy to understand, the technical solutions of the present disclosure will be further described below with reference to the drawings and the embodiments. Apparently, the described embodiments are part of the embodiments of the present disclosure, not all of the embodiments. All other embodiments obtained by those skilled in the art based on the embodiments of the present disclosure without creative efforts are within the scope of the present disclosure.

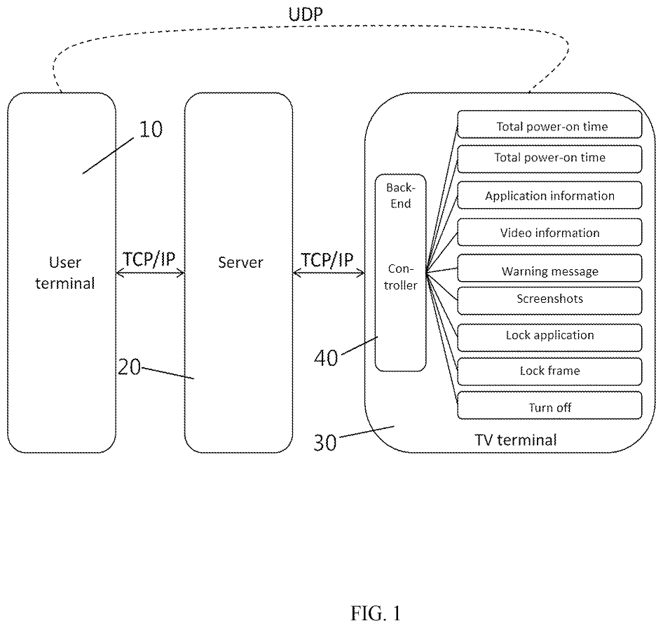

FIG. 1 is a schematic view of an embodiment of a monitoring system for smart TVs (“monitoring system”) according to the present disclosure.

The monitoring system includes an user terminal 10, a server 20, and a TV terminal 30. The user terminal 10 communicates with the server 20 via Transmission Control Protocol/Internet Protocol (TCP/IP), and the TV terminal 30 communicates with the server 20 via the TCP/IP. The user terminal 10 transmits at least one network request to the TV terminal 30 via the server 20 to conduct the operations. The TV terminal 30 includes a back-end controller 40 configured to process the network requests sent from the server 20. After the TV terminal 30 is turned on, the back-end controller 40 is turned on to record a total power-on time of the TV terminal 30. The TV terminal 30 may be associated with a QR code or a digital code. The user terminal 10 is bound to the TV terminal 30 via the QR code or the digital code such that the user terminal 10 may control the TV terminal 30.

In an embodiment, the back-end controller 40 will not be override by other applications within the TV terminal 30. When the TV terminal 30 connects to the Internet, The TV terminal 30 receives the QR code or the digital code from the server 20. The application run on the user terminal 10 is configured to scan the QR code or to input the digital code so as to bound with the TV terminal 30. After the bounding process, the application run on the user terminal 10 is configured to send the network requests to control the TV terminal 30. As such, the parents may use the user terminal 10 to remotely control the TV terminal 30 even they are not at home.

After the TV terminal 30 is turned on, the back-end controller 40 begins to record the total power-on time of the TV terminal 30. The application run on the user terminal 10 may send the network request to inquire the total power-on time of the TV terminal 30 to the back-end controller 40 via the server 20. Afterward, the back-end controller 40 transmits the total turn-on time of the TV terminal 30 to the user terminal 10, which may be displayed on the user terminal 10 via the application.

In an embodiment, the TV terminal 30 is configured with a power-on password. The back-end controller 40 sends a verification code to the user terminal 10, and the power-on password is activated after the verification code is input at the TV terminal 30.

In an embodiment, the power-on password may be disabled. In response to an user request to disable the power-on password, the back-end controller 40 sends the verification code to the user terminal 10. The power-on password may be disabled by inputting the verification code on the TV terminal 30.

In an embodiment, the back-end controller 40 is configured to record the information relating to the applications being activated on the TV terminal 30. In an example, the information may include a name of the application, and running time of the application. Taking the Android smart TV as an example, the back-end controller 40 activates an activity manager running on the back-end controller 40. The activity manager is configured to record the information relating to the applications being activated on the TV terminal 30. As such, the back-end controller 40 transmit the information relating to the applications to the user terminal 10 via the server 20.

Further, the back-end controller 40 is configured to record a time duration and a video interface relating to the videos played by the TV terminal 30 through the video interfaces, including ATV/DTV/AV/HDMI. The videos may include the videos played by the applications or the videos transmitted to the TV terminal 30 via the video interfaces, including but not limited to, ATV/DTV/AV/HDMI.

In an embodiment, the TV terminal 30 is configured to capture the screenshots on a display of the TV terminal 30. The screenshots may be saved in picture formats including bmp, jpeg, and png, and the pictures may be transmitted to the user terminal 10 by the back-end controller 40.

In an embodiment, the TV terminal 30 is configured to record the screen. The TV terminal 30 saves the screen, i.e., osd+video data, as a TS stream. the TV terminal 30 communicates with the user terminal 10 through the User Datagram Protocol (UDP) protocol, and the TS stream may be directly transmitted to the user terminal 10. Inn an embodiment, the back-end controller 40 is configured to adjust the resolution of the TS stream according to the network quality between the user terminal 10 and the TV terminal 30. The resolution may include, but not limited to, 480P, 720P, and 1080P.

In an embodiment, the back-end controller 40 is configured to display a warning message on the TV terminal 30. The user may input the warning message via the user terminal 10. The warning message may be displayed on the TV terminal 30 in response to the network request sent from the server 20.

In an embodiment, the applications run on the TV terminal 30 may be locked by the back-end controller 40 in response to the network request sent from the server 20. Taking Android smart TV as one example, a lock limitation may be configured as an attribute of the application by the activity manager. When the back-end controller 40 receives the network request relating to the lock limitation, the activity manager maintains an application blacklist. The application on the application blacklist will not be activated even its icon has been clicked on the TV terminal 30.

In an embodiment, the back-end controller 40 is configured to display a lock frame on the TV terminal 30. At the same time, the back-end controller 40 transmits an unlock password to the user terminal 10. The back-end controller 40 intercepts all button actions except the power button of the TV terminal 30. It is to be noted that, even the TV terminal 30 is turned off, the lock frame is displayed on the TV terminal 30, after the TV terminal 30 is rebooted. The lock frame is disabled only when the unlock password is inputted on the TV terminal 30.

In an embodiment, the back-end controller 40 is configured to turn off the TV terminal 30, in response to the user command input on the user terminal 10, or to turn off the TV terminal 30 after a time period associated with a turn-off timer. Such user request may be transmitted from the user terminal 10 to the TV terminal 30 via the server 20.

The descriptions of the forgoing embodiment are only used to help understand the technical schemes of the present disclosure and their core ideas. At the same time, for those skilled in the art, according to the ideas of the present disclosure, there will be changes in the specific implementation and the application scope. In summary, the contents of the present disclosure should not be construed as limitations to the present disclosure.

What is claimed is:

1. A monitoring system for smart TVs, comprising:
an user terminal, a server, and a TV terminal being communicated with each other via Transmission Control Protocol/Internet Protocol (TCP/IP);
the TV terminal comprising a back-end controller configured to process network requests sent from the user terminal via the server, and to record a total power-on time of the TV terminal; and
the TV terminal being associated with a QR code or a digital code, and the user terminal being bound to the TV terminal via the QR code or the digital code such that operations of the TV terminal is controllable in accordance with commands inputted on the user terminal.

2. The system according to claim 1, wherein the TV terminal is configured with a power-on password, the back-end controller sends a verification code to the user terminal, and the power-on password is activated after the verification code is input at the TV terminal.

3. The system according to claim 1, wherein the back-end controller configured to record information relating to applications being activated on the TV terminal, and the information comprises a name of the application, and running time of the application.

4. The system according to claim 1, wherein the back-end controller is configured to record a time duration and a video interface relating to the videos played by the TV terminal through the applications or through video interfaces comprising ATV/DTV/AV/HDMI.

5. The system according to claim 1, wherein the TV terminal is configured to capture the screenshots on a display of the TV terminal, and the screenshots are saved in picture formats comprising bmp, jpeg and png, and the screenshots are transmitted to the user terminal 10 by the back-end controller 40.

6. The system according to claim 1, wherein the TV terminal is configured to record the screen and to save the screen as a TS stream, the TV terminal communicates with the user terminal through the User Datagram Protocol (UDP) protocol to transmit the TS stream directly to the user terminal.

7. The system according to claim 1, wherein the back-end controller is configured to display a warning message on a display of the TV terminal, the warning message is edited by users of the user terminal, and the warning message may be displayed on the TV terminal in response to the network request sent via the server.

8. The system according to claim 1, wherein the back-end controller is configured to lock at least one application run on the TV terminal in response to the network request sent from the server.

9. The system according to claim 1, wherein the back-end controller is configured to display a lock frame on the TV terminal and to transmit an unlock password to the user terminal, and the back-end controller intercepts all button actions except the power button of the TV terminal.

10. The system according to claim 1, wherein the back-end controller is configured to turn off the TV terminal in response to the user command input on the user terminal or to turn off the TV terminal after a time period associated with a turn-off timer.
